(19) United States
(12) Patent Application Publication
(10) Pub. No.: US 2007/0064438 A1
(43) Pub. Date: Mar. 22, 2007

(54) Lamp unit for a vehicle headlamp

(76) Inventor: Hiroyuki Ishida, Shizuoka (JP)

Correspondence Address: FISH & RICHARDSON P.C., P.O. BOX 1022, MINNEAPOLIS, MN, 55440-1022, US

(21) Appl. No.: 11/506,249

(22) Filed: Aug. 18, 2006

(30) Foreign Application Priority Data
Sep. 13, 2005 (JP) P.2005-264882

(51) Int. Cl. F21V 7/00

(52) U.S. Cl. 362/516

(57) ABSTRACT

A headlamp for a vehicle including a light-emitting device 14 that faces downward and is placed on an optical axis Ax, a reflector 16 which covers the device from the lower side, a mirror member 18 which reflects part of reflected light from a reflector 16 downward is disposed between the reflector 16 and a projection lens 12. The mirror member 18 has a downward reflecting surface 18a which extends rearward in parallel with the optical axis Ax from the vicinity of the rear focal point F in proximity to a portion above the optical axis Ax. In reflected light from the reflector 16, light which passes through the back focal plane of the projection lens 12 at a position which is above the optical axis Ax passes through a position which is close to the optical axis Ax.

This application claims foreign priority from Japanese Patent Application No. 2005-264882, filed Sep. 13, 2005, the entire contents of which are hereby incorporated by reference.

### BACKGROUND OF THE INVENTION

1. Field of the Invention

The present invention relates to a lamp unit for a vehicle headlamp, and more particularly to a projector type lamp unit in which a light-emitting device, such as a light-emitting diode, is used as a light source.

2. Background Art

Recently, a light-emitting device, such as a light-emitting diode, has been used as a light source for a vehicle headlamp.

For example, JP-A-2003-317513 (“JP '513”) discloses projector type lamp unit including: a projection lens which is placed on an optical axis extending in a longitudinal direction of a vehicle; a light-emitting device which faces upward and is placed rearward of a rear focal point of the projection lens in proximity to the optical axis; and a reflector which is placed so as to cover the light-emitting device from the upper side, and which reflects light from the light-emitting device forward while shifting the light toward the optical axis.

In the lamp unit disclosed in JP '513, a mirror member having an upward reflecting surface, which extends rearward in parallel with the optical axis from the vicinity of the rear focal point of the projection lens is disposed between the reflector and the projection lens. Part of reflected light from the reflector is upward reflected by the mirror member, thereby forming a low-beam light distribution pattern which in an upper end portion has a cut-off line as an inverted projection image of a front end edge of the upward reflecting surface. FIG. 13 of JP '513 also shows a lamp unit in which the mirror member is not disposed, whereby a high-beam light distribution pattern is formed.

In contrast, JP-A-2000-348508 (“JP '508”) discloses a projector type lamp unit which does not use a light-emitting device as a light source and includes a movable mirror member. The mirror member can be swung downward by a predetermined angle about a swing axis that extends in a rear end portion of the mirror member in the vehicle width direction.

When the movable mirror member disclosed in JP '508 is used in the projector type lamp unit which is disclosed in JP '513, in which a light-emitting device is used as a light source, a high-beam light distribution pattern can be formed by swinging the mirror member downward by the predetermined angle. Therefore, the illumination range can be expanded above the cut-off line of the low-beam light distribution pattern. Therefore, beam switching between a low beam and a high beam is enabled.

However, in the high-beam light distribution pattern formed by the lamp unit disclosed in JP '508, the lower half portion is formed while maintaining the shape and luminous distribution of the low-beam light distribution pattern. Therefore, for a high-beam light distribution pattern, a short-distance range of a road surface in front of a vehicle is excessively illuminated. There arises a problem in that the visibility of the long-distance range of a road surface in front of a vehicle is not ensured.

This problem also arises in the high-beam lamp unit disclosed in FIG. 13 of JP '513.

The invention has been conducted in view of such circumstances.

### SUMMARY OF THE INVENTION

One aspect of the invention is lamp unit for a vehicle headlamp, including: a projection lens which is placed on an optical axis extending in a longitudinal direction of a vehicle; a light-emitting device which is placed more rearward than a rear focal point of the projection lens; and a reflector which forward reflects light from the light-emitting device while shifting the light toward the optical axis, wherein the light-emitting device faces downward and is placed in proximity to the optical axis, the reflector is placed to cover the light-emitting device from a lower side, a mirror member having a downward reflecting surface is disposed between the reflector and the projection lens, the reflecting surface extending rearward from a vicinity of the rear focal point, in proximity to a portion above the optical axis and in substantially parallel with the optical axis, and part of reflected light from the reflector is downward reflected by the mirror member.

The “light-emitting device” in this invention means a light source having a solid state light-emitting device such as a light-emitting chip which emits light in a substantially point-like manner. In this regard, the type of the light-emitting device is not particularly restricted. For example, a light-emitting diode, a laser diode, or the like can be employed. Furthermore, the “light-emitting device” faces downward and is placed in proximity to the optical axis. However, it is not necessary that the light-emitting device faces only in a vertically downward direction.

In the above, the “mirror member” has the downward reflecting surface which extends rearward from the vicinity of the rear focal point of the projection lens, in proximity to a portion above the optical axis and substantially in parallel with the optical axis. The specific value of the upward shifting amount of “downward reflecting surface” from the optical axis is not particularly restricted as long as part of the light reflected from the reflector can be reflected downward.

Moreover, the manner of movement of the “mirror member” is not particularly restricted.

### BRIEF DESCRIPTION OF THE DRAWINGS

The advantages, nature, and various additional features of the invention will appear more fully upon consideration of the exemplary embodiments. The exemplary embodiment and modifications thereof are set forth in the following drawings.

FIG. 1 is a front view showing a lamp unit for a vehicle headlamp of a first exemplary embodiment of the invention.

FIG. 2 is a section view taken along line II-II of FIG. 1.

FIG. 3 is a view showing in a transparent manner a high-beam light distribution pattern which is formed on a virtual vertical screen placed at a position 25 m forward from a vehicle by light emitted forward from the lamp unit.

FIG. 4 is a view similar to FIG. 2 showing a lamp unit for a vehicle headlamp of a second exemplary embodiment of the invention.

FIG. 5 is a view similar to FIG. 2 showing in detail an optical path in a low-beam state in the lamp unit of the second exemplary embodiment.

FIG. 6 is a view similar to FIG. 2 showing in detail an optical path in a high-beam state in the lamp unit of the second exemplary embodiment.

FIG. 7 is a view showing in a transparent manner a low-beam light distribution pattern which is formed on the virtual vertical screen by light forward emitted from the lamp unit of the second exemplary embodiment.

FIG. 8 is a view showing in a transparent manner a high-beam light distribution pattern which is formed on the virtual vertical screen by light forward emitted from the lamp unit of the second exemplary embodiment.

FIG. 9 is a view similar to FIG. 2 showing another use example of the lamp unit of the second exemplary embodiment.

FIG. 10 is a view showing in a transparent manner a low-beam light distribution pattern which is formed on the virtual vertical screen by the use example shown in FIG. 9.

FIG. 11 is a view similar to FIG. 2 showing a further use example of the lamp unit of the second exemplary embodiment.

FIG. 12 is a view showing in a transparent manner a high-beam light distribution pattern which is formed on the virtual vertical screen by the use example shown in FIG. 11.

### DETAILED DESCRIPTION OF THE EXEMPLARY EMBODIMENTS

Although the invention will be described with respect to exemplary embodiments, the following exemplary embodiments do not limit the invention.

First, a first exemplary embodiment of the invention will be described.

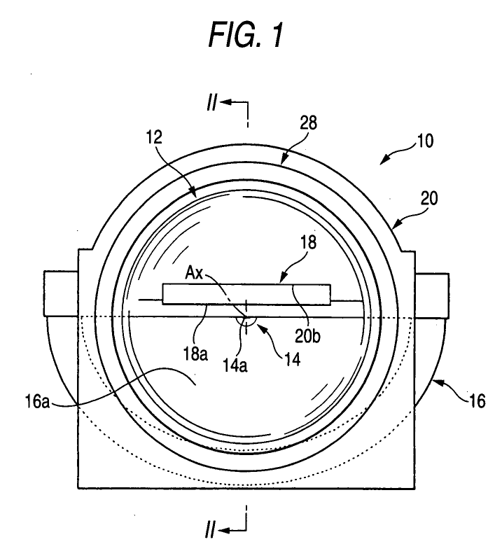

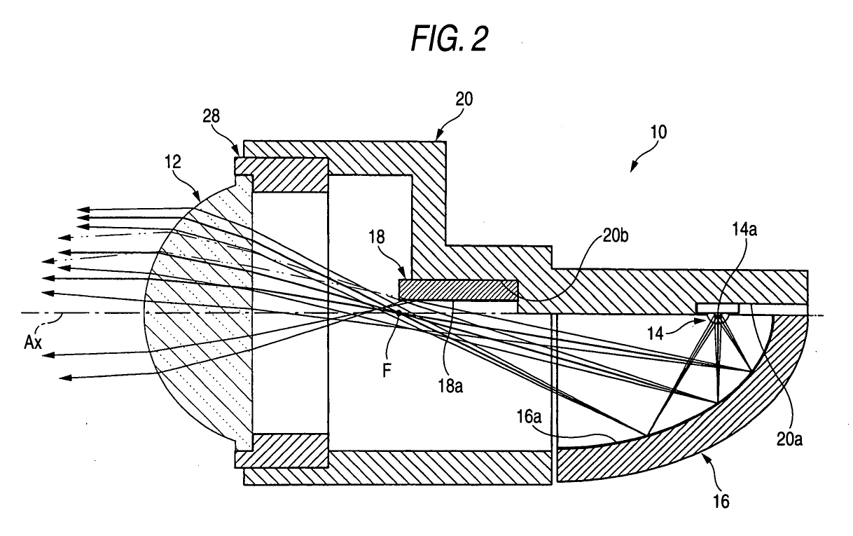

FIG. 1 is a front view showing a lamp unit 10 of the exemplary embodiment, and FIG. 2 is a section view taken along line II-II of FIG. 1.

As shown in the figures, the lamp unit 10 of the first exemplary embodiment is a high-beam lamp unit which is incorporated as a part of a vehicle headlamp. The lamp unit 19 includes: a projection lens 12 which is placed on an optical axis Ax extending in the longitudinal direction of a vehicle; a light-emitting device 14 which is placed rearward of a rear focal point F of the projection lens 12; a reflector 16 which covers the light-emitting device 14 from a lower side, and which reflects light from the light-emitting device 14 forward while shifting the light toward the optical axis Ax; and a mirror member 18 which is disposed between the reflector 16 and the projection lens 12, and which reflects part of reflected light downward from the reflector 16.

The projection lens 12 is configured as a plano-convex asperical lens in which the front surface is convex and the rear surface is planar. The projection lens 12 projects a light source image formed on the back focal plane (i.e., a focal place including the rear focal point F) as an inverted image onto a virtual vertical screen in front of the lamp unit. The projection lens 12 is secured to an annular lens holder 28 which is fixed to a base member 20.

The light-emitting device 14 is a white light-emitting diode having a light-emitting chip 14a that is a 0.3 to 3 mm square. The light-emitting device 14 is positioned and fixed to a light source supporting recess 20a formed in the lower face of the base member 20. The light-emitting chip 14a is placed on the optical axis Ax and is directed vertically downward.

A reflecting surface 16a of the reflector 16 is configured as a generally ellipsoidal curved face which has a major axis coaxial with the optical axis Ax. A luminescence center of the light-emitting device 14 is set as a first focal point of the reflecting face 16a. The eccentricity of the reflecting face 16a is set so as to gradually increase from a vertical section to a horizontal section. That is, the reflecting surface 16a is formed so that, in the vertical section, light from the light-emitting device 14 is converged to the rear focal point F of the projection lens 12, and, in the horizontal section, the converging position is moved considerably forward. The reflector 16 is fixed at an upper end portion of the periphery of the reflecting surface 16a to the lower face of the base member 20.

The mirror member 18 has a downward reflecting surface 18a which extends rearward from a position in the vicinity of the rear focal point F along the optical axis Ax. The downward reflecting surface 18a is configured as a horizontal face, and the front end edge is formed so as to linearly extend in a direction perpendicular to the optical axis Ax. The mirror member 18 is positioned and fixed to a mirror supporting recess 20b formed in the lower face of the base member 20 so that the downward reflecting surface 18a is placed at a position which is 2 to 4 mm above the optical axis Ax.

The mirror member 18 is configured so that, of the light from the light-emitting device 14 and reflected by the reflecting surface 16a of the reflector 16, part of light which is directed toward a position above the rear focal point F of the projection lens 12 is reflected downward by the downward reflecting surface 18a.

The function of the mirror member 18 will be described in detail.

Of the light emitted from portions of the light-emitting chip 14a of the light-emitting device 14, light from the front half portion of the light-emitting chip 14a is reflected by the reflecting surface 16a of the reflector 16, then formed as light which is directed upward with respect the rear focal point F of the projection lens 12 and passes through the back focal plane of the projection lens 12 in the side above the optical axis Ax.

Since the mirror member 18, having the downward reflecting surface 18a extending rearward from a position above and in the vicinity of the rear focal point F of the projection lens 12, is disposed between the reflector 16 and the projection lens 12, however, part of reflected light from the reflector 16 which is directed toward a position above the rear focal point F (specifically, light which is to pass through the back focal plane of the projection lens 12 at a position which is far above the optical axis Ax) is reflected by the downward reflecting surface 18a of the mirror member 18 and passes through the back focal plane of the projection lens 12 at a height position which is close to the optical axis Ax.

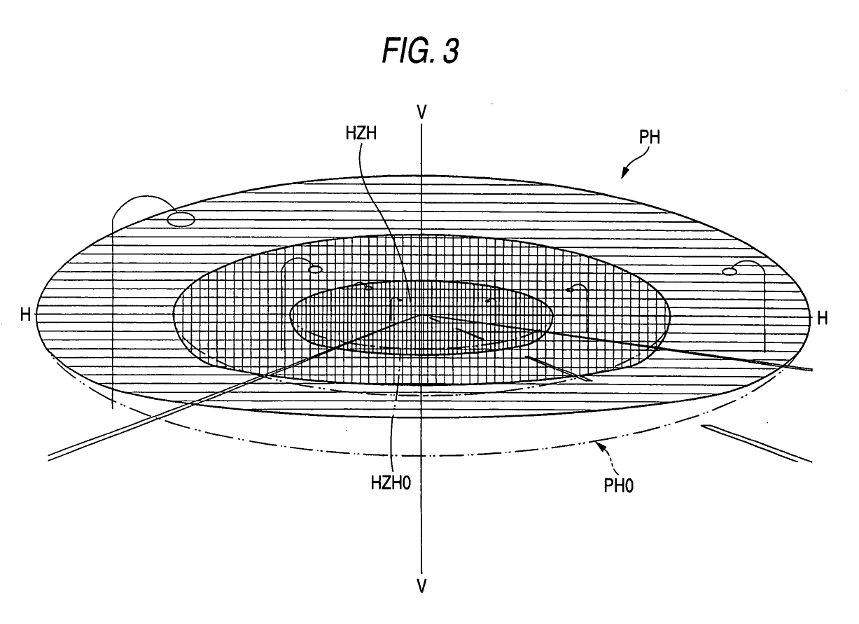

FIG. 3 is a view showing in a transparent manner a high-beam light distribution pattern PH which is formed on the virtual vertical screen placed at a position 25 m forward from a vehicle by light forward emitted from the lamp unit 10 of the exemplary embodiment.

The high-beam light distribution pattern PH is formed as a horizontally extending light distribution pattern which extends vertically and horizontally while being centered at H-V, that is a vanishing point in the front direction of the lamp. A hot zone HZH which is a high brightness area of the pattern has a generally ellipsoidal shape which horizontally extends while being centered at H-V.

A high-beam light distribution pattern PH0, indicated by the two-dot chain line in the figure, is a light distribution pattern which would be formed by the lamp unit 10 of the exemplary embodiment if the mirror member 18 is not disposed. The high-beam light distribution pattern PH0 has a shape which is substantially vertically symmetric about line H-H and which horizontally passes through H-V. A hot zone HZH0 of the pattern has a generally ellipsoidal shape which extends horizontally while being centered at H-V.

In the high-beam light distribution pattern PH, the upper half portion which is situated higher than the line H-H has a shape and brightness distribution which are substantially identical with those of the upper half portion of the high-beam light distribution pattern PH0. However, the lower half portion which is situated lower than the line H-H has a shape in which the position of a lower end portion is upward shifted with respect to the lower half portion of the high-beam light distribution pattern PH0. Moreover, the lower half portion of the hot zone HZH is slightly expanded more than that of the hot zone HZH0 of the high-beam light distribution pattern PH0.

As described above, the high-beam light distribution pattern PH is formed so that the position of the lower end portion is shifted upward with respect to the high-beam light distribution pattern PH0 and has a brightness distribution in which the brightness rapidly increases from the lower end portion to the central portion. Therefore, illumination on a short-distance range of a road surface in front of a vehicle is suppressed, and the visibility of the long-distance range of the road surface in front of the vehicle is enhanced.

In this case, in the lower half portion of the high-beam light distribution pattern PH, when the position of the lower end portion is shifted upward with respect to the lower half portion of the high-beam light distribution pattern PH0, a brightness distribution is produced in which the brightness rapidly increases from the lower end portion to the central portion for the following reason. The lamp unit is configured so that, in reflected light from the reflector 16, light which is to pass through the back focal plane of the projection lens 12 at a position which is far upward from the optical axis Ax is caused to be reflected by the mirror member 18 and pass through the back focal plane of the projection lens 12 at a height position which is close to the optical axis Ax.

As described above in detail, the lamp unit 10 for a vehicle headlamp of the exemplary embodiment includes: the projection lens 12 which is placed on the optical axis Ax extending in the longitudinal direction of the vehicle; the light-emitting device 14 which is placed rearward of the rear focal point F of the projection lens 12; and the reflector 16 which reflects light from the light-emitting device 14 forward while shifting the light toward the optical axis Ax. The light-emitting device 14 faces downward and is placed on the optical axis Ax. The reflector 16 covers the light-emitting device 14 from below. The mirror member 18 having the downward reflecting surface 18a which extends rearward in parallel with the optical axis Ax from the vicinity of the rear focal point F in proximity to a portion above the optical axis Ax is disposed between the reflector 16 and the projection lens 12. The downward reflecting surface 18a is configured so that part of light which is reflected from the reflector 16 is reflected downward by the mirror member 18. Therefore, it is possible to attain the following functions and effects.

If the mirror member 18 is not disposed, all of the light reflected from the reflector 16 is incident directly on the projection lens 12, and the high-beam light distribution pattern PH is formed as an inverted projection image of a light source image which is formed on the back focal plane of the lens. Actually, the mirror member 18 is disposed, and hence part of reflected light from the reflector 16 is reflected by the downward reflecting surface 18a of the mirror member 18 and then passes through the back focal plane of the projection lens 12. At this time, light which passes through the back focal plane of the projection lens 12 at a position which is far upward the optical axis Ax is caused by the reflection by the mirror member 18 to pass through the back focal plane of the projection lens 12 at a position which is close to the optical axis Ax.

As compared with the case where the mirror member 18 is not disposed, therefore, the brightness of the lower end portion of the high-beam light distribution pattern PH can be reduced, and the central brightness of the high-beam light distribution pattern PH can be increased by light reflected by the mirror member 18. Consequently, the long-distance visibility of the high-beam light distribution pattern PH can be enhanced.

According to the exemplary embodiment, as described above, when the projector type lamp unit 10 which uses the light-emitting device 14 as the light source is employed as a lamp unit for a vehicle headlamp, the high-beam light distribution pattern PH formed by the lamp unit 10 can have an excellent long-distance visibility.

Next, a second exemplary embodiment of the invention will be described.

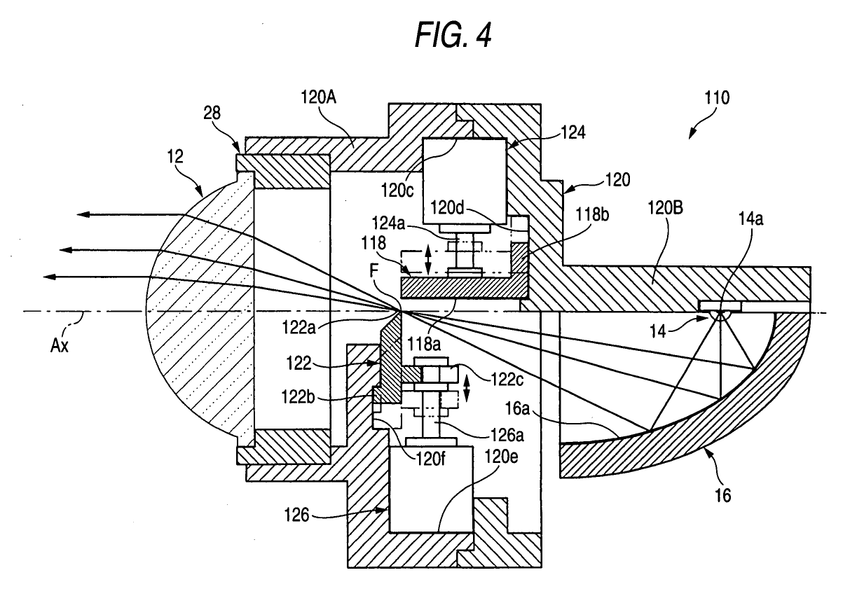

FIG. 4 is a view similar to FIG. 2 showing a lamp unit 110 of the exemplary embodiment.

As shown in the figure, the lamp unit 110 is a lamp unit which is used while being incorporated as a part of a vehicle headlamp, and which is configured so that beam switching between a low beam and a high beam is enabled.

Namely, the lamp unit 110 of the exemplary embodiment has the same basic configuration as that of the lamp unit 10 of the above-described exemplary embodiment, but is different from the lamp unit 10 of the first exemplary embodiment in that a mirror member 118 is configured as a movable mirror member, and a shade 122 for performing beam switching between a low beam and a high beam is disposed.

Furthermore, the lamp unit 110 is placed in a state where, when incorporated into a vehicle headlamp, the optical axis Ax extends in a downward direction of about 0.5 to 0.6 deg. with respect to the longitudinal direction of a vehicle.

The mirror member 118 is movable between a light reflecting position (in FIG. 4, the position indicated by the solid line, and identical with that of the mirror member 18 of the first exemplary embodiment) where a front end edge of the downward reflecting surface 118a is positioned in the vicinity of the rear focal point F of the projection lens 12, and a reflection canceling position (in FIG. 4, the position indicated by the two-dot chain line) where the reflection of the reflected light from the reflector 16 by the mirror member 118 is canceled. The movement of the mirror member 118 is provided as a linear reciprocal movement in the vertical direction by driving a solenoid 124.

The solenoid 124 is attached to a solenoid attaching portion 120c which is formed in an upper portion of a base member 120, in a state where a plunger 124a protrudes downward. The solenoid 124 is coupled and fixed in a lower end portion of the plunger 124a to the mirror member 118.

A guiding portion 118b which extends vertically upward is formed in a rear end portion of the mirror member 118. The guiding portion 118b is slid along a vertical guiding face 120d formed on the base member 120, thereby guiding the movement of the mirror member 118. When the mirror member 118 is moved to the light reflecting position or the reflection canceling position, the guiding portion 118b is caused to butt against the upper end face or lower end face of the vertical guiding face 120d of the base member 120, thereby positioning the mirror member 118.

The shade 122 is disposed between the reflector 16 and the projection lens 12 so as to block part of reflected light from the reflector 16.

The shade 122 is formed so that an upper end portion has a wedge-like section shape. The upper end edge 122a of the shade is formed so as to pass through the rear focal point F of the projection lens 12. In this case, the upper end edge 122a extends along the back focal plane of the projection lens 12, the left region which is situated on the left side of the optical axis Ax (the right side in a front view of the lamp) is configured as an upper horizontal portion the level of which is identical with the optical axis Ax, and the right region which is situated on the right side of the optical axis Ax is configured as a lower horizontal portion which is provided at a lower level than the left region via a short inclined portion.

The shade 122 is movable between a light blocking position (in FIG. 4, the position indicated by the solid line) where the upper end edge 122a is positioned at the rear focal point F of the projection lens 12, and a block canceling position (in FIG. 4, the position indicated by the two-dot chain line) where the blocking of the reflected light from the reflector 16 by the shade 122 is canceled. The movement of the shade 122 is provided as a linear reciprocal movement in the vertical direction by driving a solenoid 126.

The solenoid 126 is attached to a solenoid attaching portion 120e which is formed in a lower portion of the base member 120, in a state where a plunger 126a protrudes upward. In an upper end portion of the plunger 126a, the solenoid 126 is engaged with the shade 122. In this case, a stay 122c which extends rearward is formed on the rear face of the shade 122. The engagement with the plunger 126a is conducted in the stay 122c.

A guiding portion 122b which protrudes forward is formed in a lower end portion of the shade 122. The guiding portion 122b is slid along a vertical guiding face 120f formed on the base member 120, thereby guiding the movement of the shade 122. When the shade 122 is moved to the light blocking position or the block canceling position, the guiding portion 122b is caused to butt against the upper end face or lower end face of the vertical guiding face 120f of the base member 120, thereby positioning the shade 122.

The base member 120 has a configuration in which a front half portion 120A and a rear half portion 120B are coupled and fixed to each other so that the mirror member 118, the shade 122, and the solenoids 124, 126 can be easily placed.

The two solenoids 124, 126 are driven in an interlocked manner by operating a beam changeover switch, which is not shown.

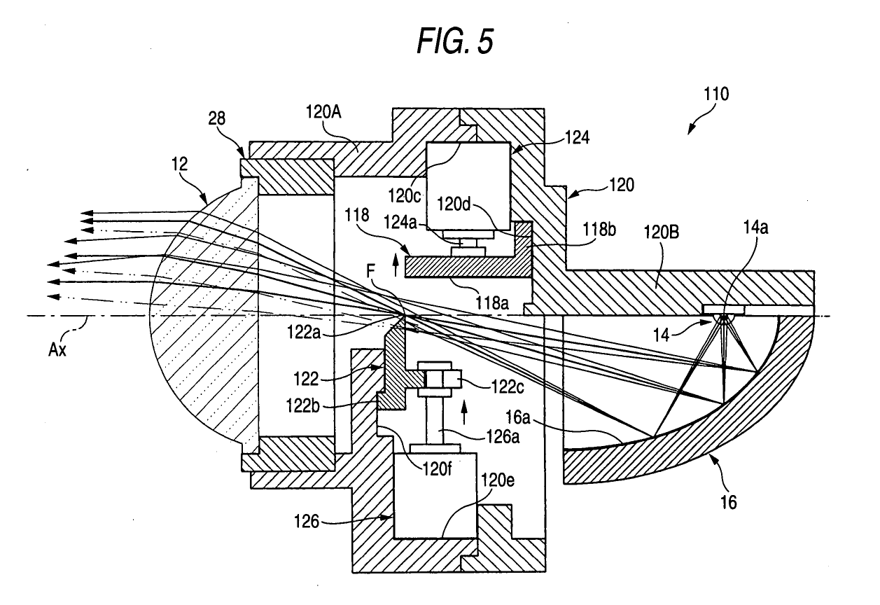

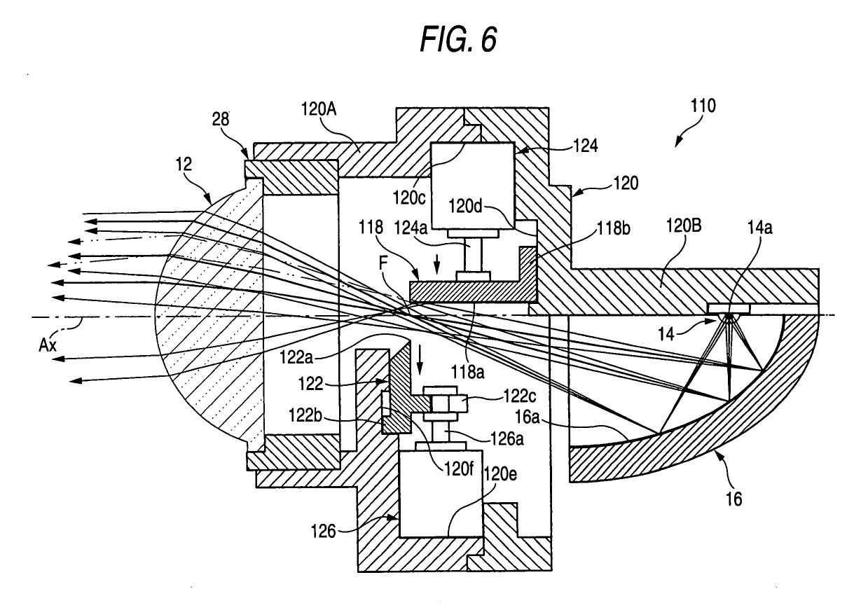

FIG. 5 is a view similar to FIG. 2 showing in detail an optical path in the low-beam state, and FIG. 6 is a view similar to FIG. 2 showing in detail an optical path in the high-beam state.

As shown in FIG. 5, when the beam changeover switch is in the low-beam position, the plunger 124a of the solenoid 124 for driving the mirror member 118 is retracted upward to move the mirror member 118 to the reflection canceling position, and the plunger 126a of the solenoid 126 for driving the shade 122 is advanced upward to move the shade 122 to the light blocking position.

In contrast, as shown in FIG. 6, when the beam changeover switch is switched to the high beam, the plunger 124a of the solenoid 124 for driving the mirror member 118 is advanced downward to move the mirror member 118 to the light reflecting position, and the plunger 126a of the solenoid 126 for driving the shade 122 is retracted downward to move the shade 122 to the block canceling position.

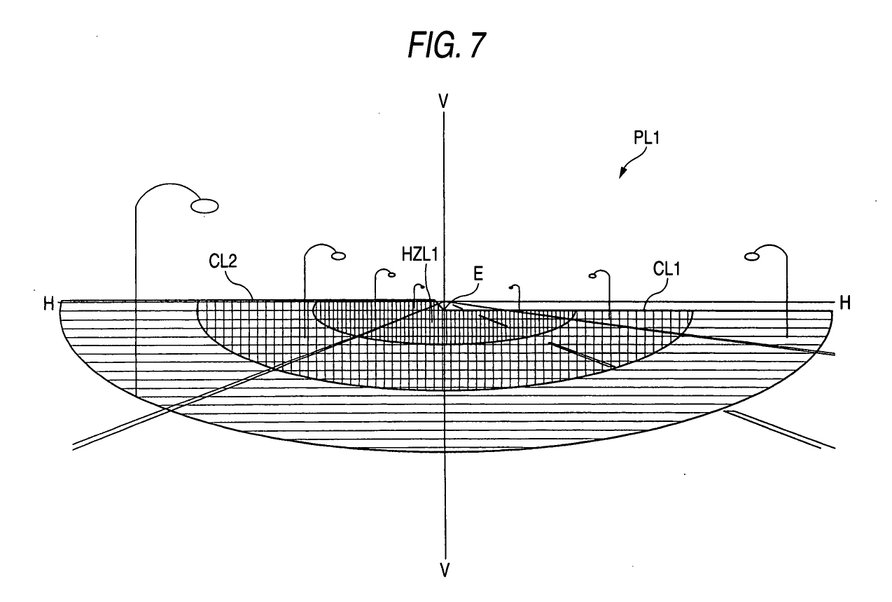

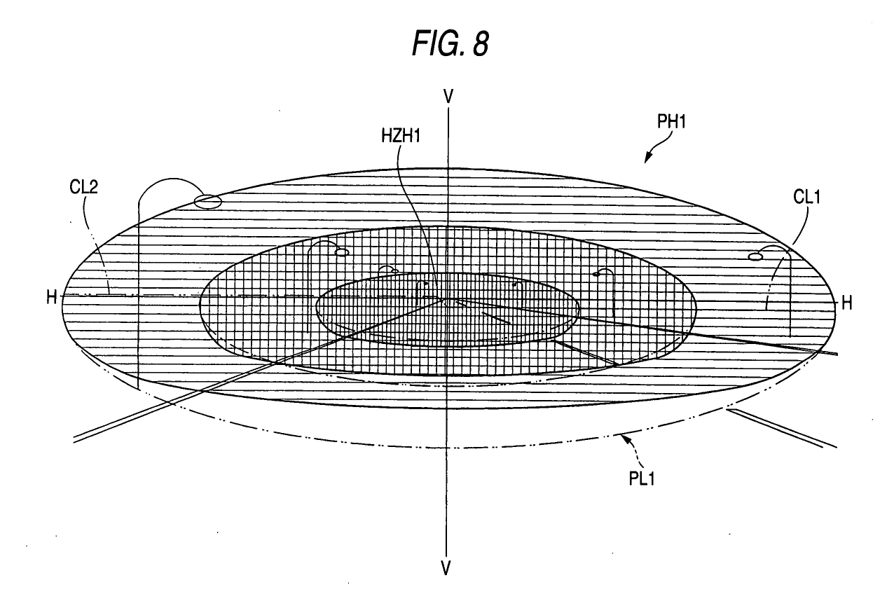

FIGS. 7 and 8 are views showing in a transparent manner a light distribution pattern which is formed on the virtual vertical screen placed at a position 25 m forward from a vehicle by light forward emitted from the lamp unit 110 of the exemplary embodiment. FIG. 7 shows a low-beam light distribution pattern PL1, and FIG. 8 shows a high-beam light distribution pattern PH1.

The low-beam light distribution pattern PL1 shown in FIG. 7 is a light distribution pattern which is formed when, as shown in FIG. 5, the mirror member 118 is at the reflection canceling position and the shade 122 is at the light blocking position.

The low-beam light distribution pattern PL1 is a low-beam light distribution pattern for left light distribution, and has right and left stepped cut-off lines CL1, CL2 in the upper end edge. The cut-off lines CL1, CL2 horizontally extend in a stepped manner on both sides of line V-V which vertically passes through H-V, that is, the vanishing point, in the front direction of the lamp. The opposite-lane portion which is on the right side of the line V-V is formed as the lower cut-off line CL1, and the own-lane portion which is on the left side of the line V-V is formed as the upper cut-off line CL2 which is stepped up from the lower cut-off line CL1 via an inclined portion.

The low-beam light distribution pattern PL1 is formed in the following manner. An image of the light-emitting device 14 is formed on the back focal plane of the projection lens 12 by light which is emitted from the light-emitting device 14 and reflected by the reflector 16. The image is projected by the projection lens 12 as an inverted projection image onto the virtual vertical screen. The cut-off lines CL1, CL2 are formed as an inverted projection image of the upper end edge 122a of the shade 122.

In the low-beam light distribution pattern PL1, an elbow point E, which is an intersection of the lower cut-off line CL1 and the line V-V, is situated below H-V by about 0.5 to 0.6 deg. This is cased by the extension in which the optical axis Ax extends in a downward direction of about 0.5 to 0.6 deg. with respect to the longitudinal direction of a vehicle. In the low-beam light distribution pattern PL1, a hot zone HZL1 is formed so as to surround the elbow point E.

The high-beam light distribution pattern PH1 shown in FIG. 8 is formed when the mirror member 118 is at the light reflecting position and the shade 122 is at the block canceling position as shown in FIG. 6.

The high-beam light distribution pattern PH1 is a light distribution pattern which is obtained by shifting downward the high-beam light distribution pattern PH formed by the lamp unit 10 of the first exemplary embodiment by about 0.5 to 0.6 deg.

Namely, in the high-beam light distribution pattern PH1, the upper half portion has a shape which is obtained by expanding the low-beam light distribution pattern PL1 to a position that is substantially vertically symmetric about the lower cut-off line CL1, and the lower half portion has a shape in which the low-beam light distribution pattern PL1 is slightly flattened toward the lower cut-off line CL1. Therefore, illumination on a short-distance range of a road surface in front of a vehicle is suppressed, and the visibility of the long-distance range of the road surface in front of the vehicle is enhanced. However, the hot zone HZH1 of the high-beam light distribution pattern PH1 is slightly downward shifted from the hot zone HZH of the high-beam light distribution pattern PH.

As described above in detail, the lamp unit 110 of the exemplary embodiment includes the movable shade 122, and hence has a configuration which can perform beam switching between a low beam and a high beam. In the high-beam state, the mirror member 118 is at the light reflecting position. As compared with the case where the mirror member 118 is at the reflection canceling position or the mirror member 118 is not disposed, therefore, the brightness of the lower end portion of the high-beam light distribution pattern PH1 can be reduced, and the central brightness of the high-beam light distribution pattern PH1 can be increased by light reflected by the mirror member 118. Consequently, the long-distance visibility of the high-beam light distribution pattern PH1 can be enhanced.

In contrast, in the low-beam state, the mirror member 118 is at the reflection canceling position, and hence the low-beam light distribution pattern PL1 can be formed so that the brightness of the lower end portion is sufficiently ensured. Therefore, the low-beam light distribution pattern PL1 can be made suitable for usual running.

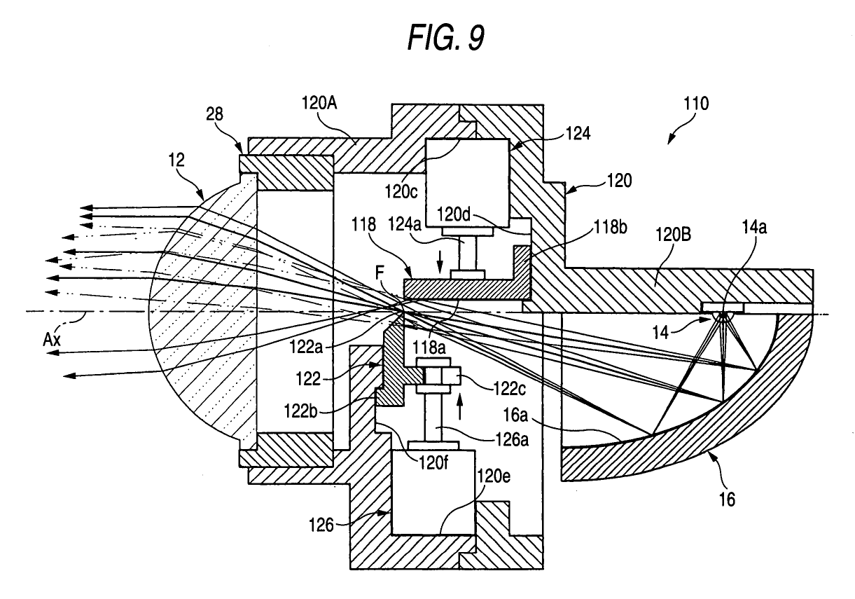

As shown in FIG. 9, it may be possible to further configure the lamp unit 110 of the exemplary embodiment so that, in the low-beam state, the mirror member 118 is moved to the light reflecting position by, for example, operating a mode changeover switch which is not shown.

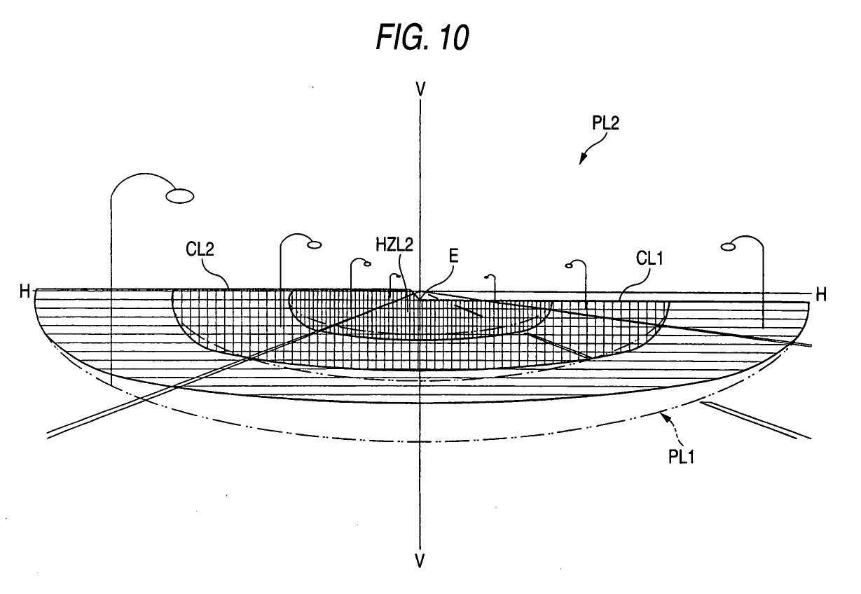

In this case, a low-beam light distribution pattern PL2 shown in FIG. 10 can be formed. The low-beam light distribution pattern PL2 has a shape in which the low-beam light distribution pattern PL1 indicated by the two-dot chain line in the figure is slightly flattened toward the lower cut-off line CL1. The brightness of the lower end portion is reduced, and that of the hot zone HZL2 is enhanced. Therefore, the pattern can be made suitable for running at high speed or in the rain.

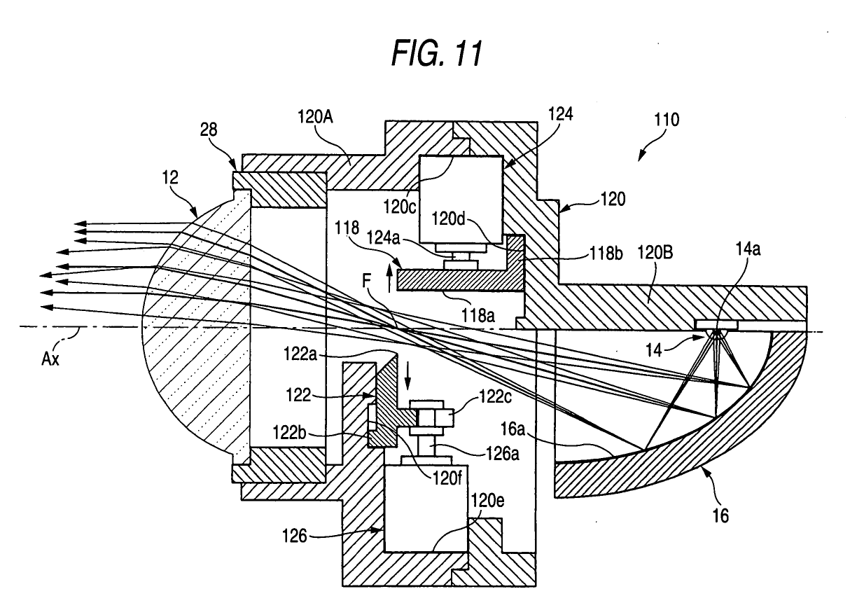

As shown in FIG. 11, it may be possible to further configure the lamp unit 110 of the exemplary embodiment so that, in the high-beam state, the mirror member 118 is moved to the reflection canceling position by, for example, operating the mode changeover switch which is not shown.

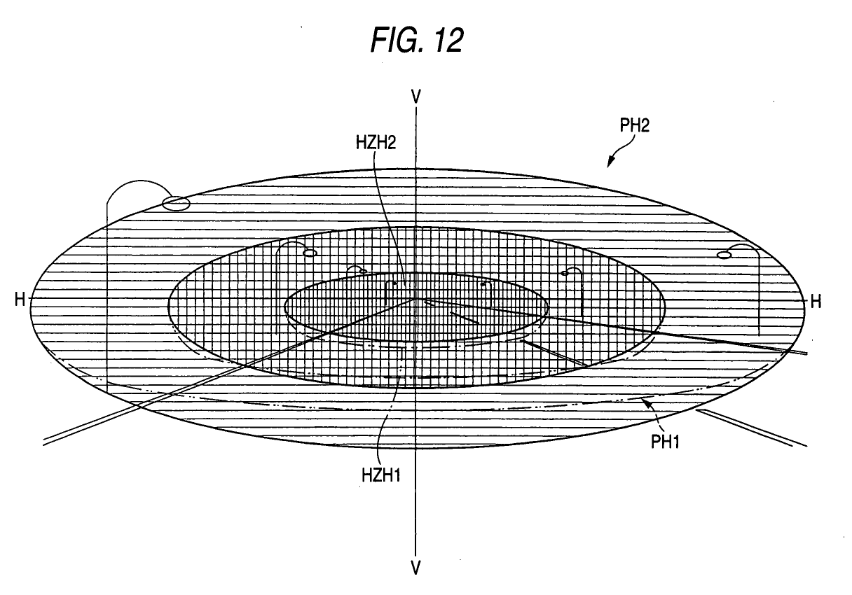

In this case, a high-beam light distribution pattern PH2 shown in FIG. 12 can be formed. In the high-beam light distribution pattern PH2, as compared with the high-beam light distribution pattern PH1 indicated by the two-dot chain line in the figure, the hot zone HZH2 is slightly darker than the hot zone HZH1, but the brightness of the lower end portion is can be enhanced. Therefore, the pattern can be made suitable for running on mountain roads.

In the above exemplary embodiments, the light-emitting device 14 is placed on the optical axis Ax. However, it is possible to attain the same functions and effects as those of the exemplary embodiments if the device is placed at a position which is slightly deviated from the optical axis Ax,

In the above exemplary embodiments, the downward reflecting surfaces 18a, 118a of the mirror members 18, 118 are configured by a horizontal face. However, the downward reflecting surfaces 18a, 118a may also be configured by a flat face which is slightly inclined with respect to a horizontal plane or by a curved face of a small curvature.

In the second exemplary embodiment, the movement of each of the mirror member 118 and the shade 122 is a linear reciprocal movement in the vertical direction. However, another moving mode (for example, linear reciprocal movement in the longitudinal direction or swing movement about an axis which extends in the vehicle width direction) may be employed.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

What is claimed is:

1. A lamp unit for a vehicle headlamp, comprising:
a projection lens which is placed on an optical axis extending in a longitudinal direction of a vehicle;
a light-emitting device which is placed rearward of a rear focal point of said projection lens, wherein said light-emitting device faces downward and is placed in proximity to the optical axis;
a reflector which reflects light from said light-emitting device forward while shifting the light toward the optical axis, said reflector covering said light-emitting device from a lower side; and
a mirror member having a downward reflecting surface and disposed between said reflector and said projection lens, said reflecting surface extending rearward from a vicinity of the rear focal point, in proximity to a portion above the optical axis and substantially in parallel with the optical axis, wherein part of light reflected from said reflector is reflected downward by said mirror member.

2. The lamp unit according to claim 1, further comprising:
a shade in which an upper end edge passes through a vicinity of the rear focal point is disposed between said reflector and said projection lens, and part of the reflected light from said reflector is blocked by said shade.

3. The lamp unit according to claim 2, wherein said shade is movable between a light blocking position in which the upper end edge of said shade is positioned in a vicinity of the rear focal point and a block canceling position in which the blocking of the reflected light from said reflector by said shade is canceled.

4. The lamp unit according to claim 1, wherein said mirror member is movable between a light reflecting position in which a front end edge of said downward reflecting surface of said mirror member is positioned in a vicinity of the rear focal point in proximity to a portion above the optical axis and a reflection canceling position in which the reflection of the reflected light from said reflector by said mirror member is canceled.

5. The lamp unit according to claim 2, wherein said mirror member is movable between a light reflecting position in which a front end edge of said downward reflecting surface of said mirror member is positioned in a vicinity of the rear focal point in proximity to a portion above the optical axis and a reflection canceling position in which the reflection of the reflected light from said reflector by said mirror member is canceled.

6. The lamp unit according to claim 3, wherein said mirror member is movable between a light reflecting position in which a front end edge of said downward reflecting surface of said mirror member is positioned in a vicinity of the rear focal point in proximity to a portion above the optical axis and a reflection canceling position in which the reflection of the reflected light from said reflector by said mirror member is canceled.

7. The lamp unit according to claim 1, wherein the mirror member includes a flat face.

8. The lamp unit according to claim 2, wherein the mirror member includes a flat face.

9. The lamp unit according to claim 3, wherein the mirror member includes a flat face.

10. The lamp unit according to claim 4, wherein the mirror member includes a flat face.

11. The lamp unit according to claim 4, wherein the mirror member is movable in a vertical direction.

12. The lamp unit according to claim 5, wherein the mirror member is movable in a vertical direction.

13. The lamp unit according to claim 6, wherein the mirror member is movable in a vertical direction.

14. The lamp unit according to claim 10, wherein the mirror member is movable in a vertical direction.

15. The lamp unit according to claim 3, wherein the shade is movable in a vertical direction.

16. The lamp unit according to claim 6, wherein the shade is movable in a vertical direction.

17. The lamp unit according to claim 9, wherein the shade is movable in a vertical direction.

18. The lamp unit according to claim 13, wherein the shade is movable in a vertical direction.
